(19) United States
(12) Patent Application Publication
(10) Pub. No.: US 2007/0047960 A1
(43) Pub. Date: Mar. 1, 2007

(54) Method and apparatus for controlling level of each signal included in wavelength-multiplexed signal

(75) Inventors: Takeshi Noma, Fukuoka (JP); Akira Yamamoto, Fukuoka (JP); Katsumi Sugawa, Fukuoka (JP); Hisayuki Ojima, Kawasaki (JP); Haruki Tanaka, Fukuoka (JP); Hideaki Sugiya, Kawasaki (JP); Koji Bato, Fukuoka (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/349,180

(22) Filed: Feb. 8, 2006

(30) Foreign Application Priority Data
Aug. 30, 2005 (JP) 2005-249833

(51) Int. Cl. H04J 14/02

(52) U.S. Cl. 398/79

(57) ABSTRACT

A method for an intermediate node to control a level of a signal included in a wavelength-multiplexed signal and transmitted from a source node to a destination node via the intermediate node, includes: detecting a level of the signal; identifying a position of the intermediate node with respect to the source node; determining a control time based on the position; controlling, when the control time has elapsed from the detecting, a level of the signal based on the level detected at the detecting.

### CROSS-REFERENCE TO RELATED APPLICATIONS

This application is based upon and claims the benefit of priority from the prior Japanese Patent Application No. 2005-249833, filed on Aug. 30, 2005, the entire contents of which are incorporated herein by reference.

### BACKGROUND OF THE INVENTION

1. Field of the Invention

The present invention relates to a technology for controlling the level of each signal included in a wavelength-multiplexed signal respectively and appropriately.

2. Description of the Related Art

In wavelength division multiplexing (WDM) optical transmission systems, power and optical signal-to-noise ratio (SNR) of each of wavelengths being multiplexed largely affect transmission characteristics, and this requires control so that the power of each of the wavelengths is equalized. As a method for this, the following method is employed. In this method, each input of wavelengths is controlled by inputting it to a variable optical attenuator (VAT) and attenuating the power thereof.

FIG. 6 is a diagram of a WDM optical transmission system in which conventional wavelength multiplexing apparatuses are connected in multiple stages. In a wavelength multiplexing apparatus 1a of a node 1, a wavelength demultiplexer (DMUX) 11 demultiplexes an incident light from an input-side WDM transmission line 2a, into lights of respective wavelengths, a variable optical attenuator of a VAT controller 12 makes the level of the light fixed for each wavelength, and a wavelength multiplexer (MUX) 13 multiplexes again the lights of the wavelengths and outputs the light multiplexed to an output-side WDM transmission line 2b.

An optical supervisory channel (OSC) controller 14 in the wavelength multiplexing apparatus 1a receives information for the wavelength from a wavelength multiplexing apparatus (not shown) of an immediately preceding node, and transmits the information for the wavelength to a wavelength multiplexing apparatus 1b of a next node. The same processing is performed in the wavelength multiplexing apparatus 1b of a node 2 and in wavelength multiplexing apparatuses 1c and 1d of a node 3 and a node 4, respectively. In FIG. 6, reference numerals 2c, 2d, and 2e represent a WDM transmission line.

Normally, the VAT controller 12 detects the level of light output from the variable optical attenuator, for each wavelength, and controls so as to perform feedback of the level detected to the variable optical attenuator, thereby controlling the output level of the variable optical attenuator to a fixed value. The feedback control requires a certain control time from when the output level of light from the variable optical attenuator is detected until the output level is actually controlled.

In the conventional WDM optical transmission system, the control time of the VAT controllers 12 is the same as one another in all the wavelength multiplexing apparatuses connected in the multiple stages. Therefore, as shown in FIG. 7, fluctuation in the level of a fine light from a node in an initial stage is being accumulated toward a node in a further subsequent stage, and the amplitude of the fluctuation increases. In FIG. 7, reference numeral 31 represents a waveform of the incident light to the node 1, 32 a waveform of the output light from the node 1 (incident light to the node 2), 33 a waveform of the output light from the node 2 (incident light to the node 3), 34 a waveform of the output light from the node 3 (incident light to the node 4), and 35 a waveform of the output light from the node 4.

The accumulation of the fluctuations in the light levels occurs in the following manner. Inputs to the VAT controller 12 of each node are light waves of different frequencies with various factors. As shown in FIG. 8, when the incident light 31 of a wave with a cycle twice as long as the control time is input to the node 1, to suppress the fluctuation at time A, the VAT controller 12 controls so as to suppress its amplitude at time A in the direction of an arrow 36 and by the length of the arrow 36.

However, there is a delay, such as the control time, in the feedback control of the VAT controller 12. Therefore, in the actual case, the control, which is indicated by an arrow 37 having the same length and the same direction as these of the arrow 36, works at time A′ that is delayed from the time A by the control time. Thus, the output light 32 of the node 1 becomes a wave obtained by changing the incident light 31 to the node 1 by the length of the arrow 37. In other words, the amplitude of the output light 32 increases with respect to that of the incident light 31.

As shown in FIG. 9, the output light 32 of the node 1 becomes an incident light 32 to the node 2. In the node 2 also, the control indicated by an arrow 38 at time B actually works as the control, at time B′ delayed by the control time, indicated by an arrow 39 having the same direction and the same length as these of the arrow 38, in the same manner as that of the VAT controller 12 in the node 1. Thus, the output light 33 of the node 2 becomes a wave obtained by changing the incident light 32 to the node 2 by the length of the arrow 39. In other words, the amplitude of the output light 33 increases with respect to that of the incident light 32. The same goes for the node 3 and thereafter. The fluctuation in the light level is accumulated in this manner.

Referring to the WDM optical transmission system, the following conventional technology is known. That is, Japanese Patent Application Laid-Open No. 2004-140631 discloses a wavelength multiplexing method of multiplexing wavelengths of the incident light with a plurality of wavelengths and outputting the light multiplexed; monitoring the output light multiplexed by an optical monitor to analyze each level of the wavelengths; and adjusting each incident light of the wavelengths multiplexed according to the analyzed levels of the wavelengths, for each wavelength, in a plurality of variable optical attenuators to be made to the same level as one another. In this method, output levels of the respective variable optical attenuators are detected to control respective attenuation amounts in the variable optical attenuators according to the output levels of the variable optical attenuators and the levels analyzed.

In the conventional technology, careful consideration is not given to suppressing the accumulation of fluctuations in light levels in the configuration in which the nodes are connected in multiple stages. Therefore, when the number of connections of nodes is increased more and more, fluctuation in the level of a fine light from a node in the initial stage becomes largely accumulated, which may lead to error in a main signal.

### SUMMARY OF THE INVENTION

It is an object of the present invention to at least solve the problems in the conventional technology.

A method according to an aspect of the present invention is a method for an intermediate node to control a level of a signal included in a wavelength-multiplexed signal and transmitted from a source node to a destination node via the intermediate node. The method includes: demultiplexing the wavelength-multiplexed signal to extract the signal; detecting a level of the signal; identifying a position of the intermediate node with respect to the source node; determining a control time based on the position; controlling, when the control time has elapsed from the detecting, a level of the signal based on the level detected at the detecting; and multiplexing the signal into the wavelength-multiplexed signal.

An apparatus according to an aspect of the present invention functions as an intermediate node and controls a level of a signal included in a wavelength-multiplexed signal and transmitted from a source node to a destination node via the apparatus. The apparatus includes: a demultiplexing unit that demultiplexes the wavelength-multiplexed signal to extract the signal; a detecting unit that detects a level of the signal; an identifying unit that identifies a position of the apparatus with respect to the source node; a determining unit that determines a control time based on the position; a control unit that controls, when the control time has elapsed from when the level of the signal is detected by the detecting unit, a level of the signal based on the level detected by the detecting unit; and a multiplexing unit that multiplexes the signal into the wavelength-multiplexed signal.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram for explaining a wavelength multiplexing apparatus according to the present invention;

FIG. 2 is a diagram for explaining a relevant part of the wavelength multiplexing apparatus;

FIG. 3 is a diagram for explaining a sequence of a wavelength multiplexing method according to the present invention;

FIG. 4 is a diagram of how fluctuations in light levels are suppressed in the present invention;

FIG. 5 is a diagram for explaining the principle of how fluctuation in a light level is suppressed in the present invention;

FIG. 6 is a diagram for explaining a conventional wavelength multiplexing apparatus;

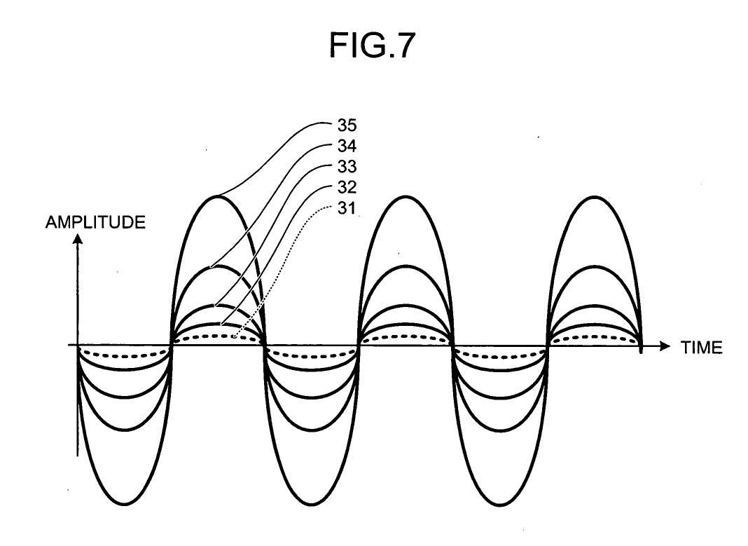

FIG. 7 is a diagram of how fluctuations in light levels are accumulated in a conventional technology; and

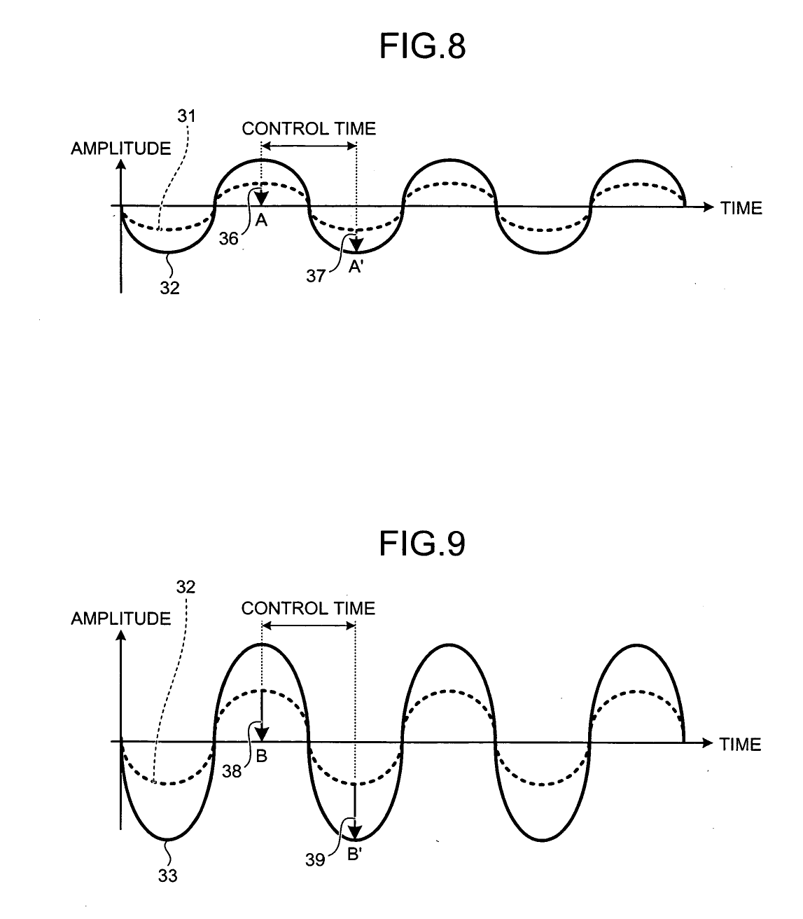

FIGS. 8 and 9 are diagrams for explaining the principle of how fluctuation in a light level is accumulated in the conventional technology.

### DETAILED DESCRIPTION OF THE PREFERRED EMBODIMENTS

Exemplary embodiments of a wavelength multiplexing method and an apparatus therefor according to the present invention are explained in detail below with reference to the accompanying drawings.

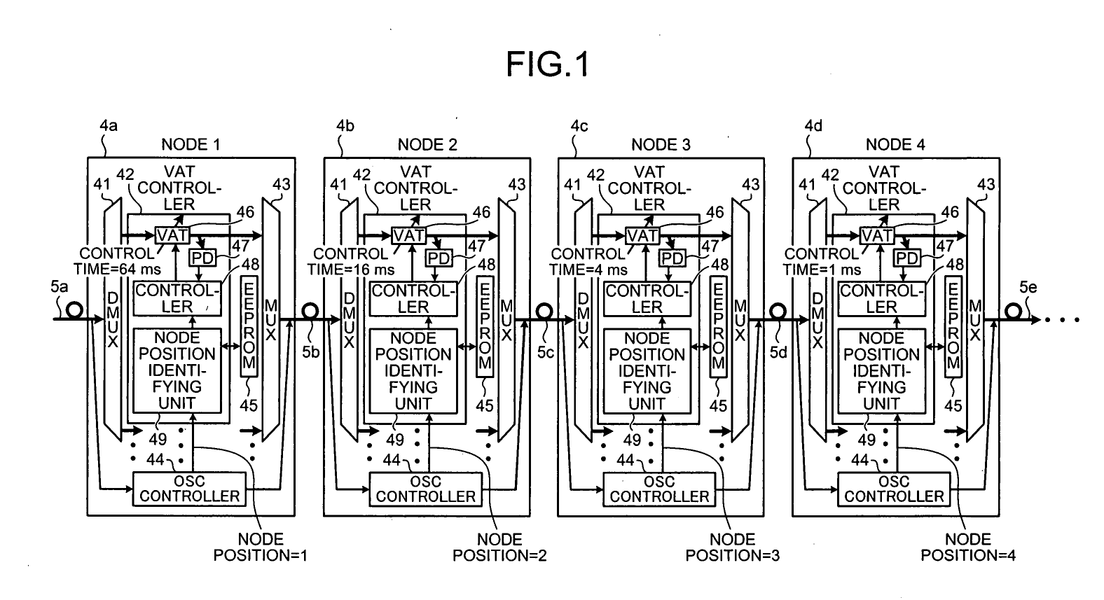

FIG. 1 is a diagram of an example of a WDM optical transmission system in which wavelength multiplexing apparatuses according to the present invention are connected in multiple stages. In a wavelength multiplexing apparatus 4a of a node 1, a wavelength demultiplexer (DMUX) 41 demultiplexes an incident light from an input-side WDM transmission line 5a into lights of respective wavelengths. And a variable optical attenuator 46 of a VAT controller 42 controls levels of the lights so as to be fixed for each wavelength, and then, a wavelength multiplexer (MUX) 43 multiplexes again the lights of the wavelengths and outputs the light multiplexed to an output-side WDM transmission line 5b.

The VAT controller 42 braches part of the light output from the variable optical attenuator (VAT) 46, and detects the level of the light branched, by a photodetector (PD) 47 such as a photodiode. A controller 48 of the VAT controller 42 performs feedback control on a light attenuation amount in the variable optical attenuator 46, based on the level detected by the photodetector 47. An optical supervisory channel (OSC) controller 44 of the wavelength multiplexing apparatus 4a receives, via the WDM transmission line 5a, information for wavelengths and information to identify a position of a node from a wavelength multiplexing apparatus (not shown) of an immediately preceding node. A node position identifying unit 49 of the VAT controller 42 receives information to identify a position of its own node from the OSC controller 44.

The controller 48 of the VAT controller 42 controls a control time required for feedback control of the light attenuation amount in the variable optical attenuator 46 according to the position of the own node identified by the node position identifying unit 49. More specifically, the controller 48 controls the time from when an output level of the variable optical attenuator 46 is detected by the photodetector 47 until the control according to the output level actually works. A relationship between the position of a node and a control time is previously stored in a memory 45 that is formed with a nonvolatile memory such as an Electrically Erasable Programmable Read-Only Memory (EEPROM). The OSC controller 44 transmits, via the WDM transmission line 5b, information for wavelengths and information to identify the position of the node, to a wavelength multiplexing apparatus 4b of a next node.

The wavelength multiplexing apparatus 4b of a node 2, and wavelength multiplexing apparatuses 4c and 4d of respective node 3 and node 4 are the same as that of the wavelength multiplexing apparatus 4a. In each of the nodes, the VAT controller 42 is provided for each wavelength, but, for simplicity of the figure, FIG. 1 shows only one VAT controller 42 in each node. In FIG. 1, reference numerals 5c, 5d, and 5e represent WDM transmission lines, respectively. Furthermore, FIG. 1 shows the four stages, out of multiple stages, in which the nodes are connected to each other, but the number of connections of nodes is not limited. Therefore, nodes may be connected in five stages or more, or even two stages or three stages. These nodes connected in multiple stages construct a ring network or an open-type ring network.

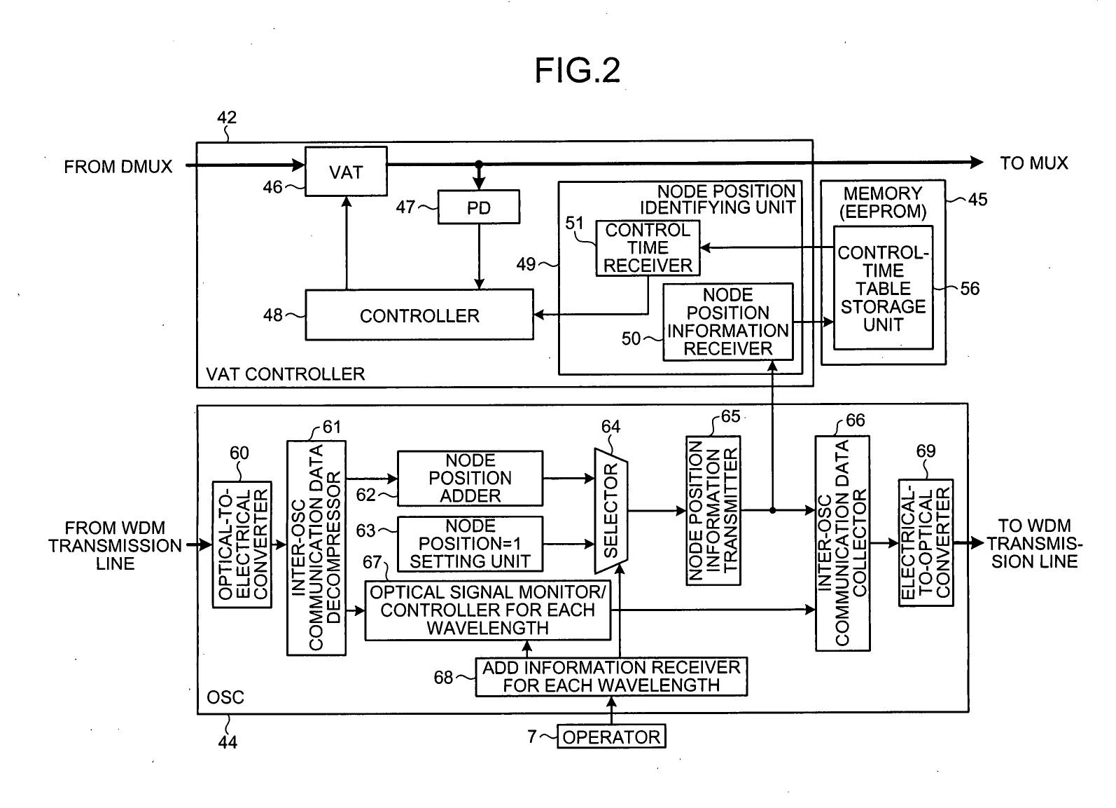

FIG. 2 is a diagram of a main portion of the wavelength multiplexing apparatus according to the present invention. The VAT controller 42 includes the variable optical attenuator 46, the photodetector 47, the controller 48, and the node position identifying unit 49. The node position identifying unit 49 includes a node position information receiver 50 and a control time receiver 51. The node position information receiver 50 receives information to identify the position of its own node from the OSC controller 44, and transmits a signal for selecting a control time corresponding to the information to identify the position of the own node.

The memory 45 includes a control-time table storage unit 56. For example, as shown in FIG. 10, the control-time table storage unit 56 stores a control-time table for defining control times corresponding to parameters for node positions, respectively. As an example, in the table shown in FIG. 10, the control times Ta, Tb, Tc, and Td are getting shorter in this order with a node position located in a more subsequent stage, in other words, following the ascending order of values (1, 2, 3, 4) to identify node positions.

The control-time table storage unit 56 selects a control time selected by the node position information receiver 50, from the control-time table, and transmits the control time selected to the control time receiver 51. The control time receiver 51 sets the time required for controlling a light level by the variable optical attenuator 46, in the control time received from the control-time table storage unit 56. The controller 48 controls the variable optical attenuator 46 using the control time set by the control time receiver 51.

The OSC controller 44 includes an optical-to-electrical converter 60, an inter-OSC communication data decompressor 61, a node position adder 62, a node positional setting unit 63, a selector 64, a node position information transmitter 65, an inter-OSC communication data collector 66, an optical signal monitor/controller 67 for each wavelength, an “Add” information receiver 68 for each wavelength, and an electrical-to-optical converter 69. The optical-to-electrical converter 60 receives an optical signal for inter-OSC communication information sent from the OSC controller 44 of an immediately preceding node, and converts the optical signal to an electrical signal. The inter-OSC communication information converted to the electrical signal is transmitted to the inter-OSC communication data decompressor 61.

The inter-OSC communication data decompressor 61 extracts a value to identify a node position from the inter-OSC communication information received from the optical-to-electrical converter 60. The value to identify a node position is stored in a data frame used for inter-OSC serial communication, for each wavelength. The value to identify a node position for each wavelength extracted is transmitted to the node position adder 62. The remaining information, of the inter-OSC communication information received from the optical-to-electrical converter 60, after the value to identify a node position for each wavelength is excluded is transmitted from the inter-OSC communication data decompressor 61 to the optical signal monitor/controller 67 for each wavelength.

The node position adder 62 adds 1 to the value to identify the node position received from the inter-OSC communication data decompressor 61, for each wavelength, to set the value as a value to identify the position of its own node, and transmits the value to identify the position of the own node to the selector 64. On the other hand, the node positional setting unit 63 sets 1 as the value to identify the position of the own node, and transmits the value to the selector 64.

The Add information receiver 68 for each wavelength receives information, indicating that the own node is a node in the initial stage for a light with a wavelength, from an operator 7, and sets the value of Add information for the light with the wavelength to, for example, 1. If the own node is not the node in the initial stage, the Add information receiver 68 sets the value of Add information to, for example, 0. The node in the initial stage indicates a node on a network to which light is initially input.

When the value of Add information transmitted from the Add information receiver 68 for each wavelength is 0, the selector 64 selects the value (value of a preceding node position+1) received from the node position adder 62 provided for each wavelength, as a value to identify the position of the own node for each wavelength, and selects the value “1” received from the node positional setting unit 63 when the value of Add information is 1. The value to identify the position of the own node selected by the selector 64 is transmitted to the node position information transmitter 65.

The node position information transmitter 65 transmits the value to identify the position of the own node received from the selector 64, to the inter-OSC communication data collector 66 and to the node position information receiver 50 of the VAT controller 42. How to control the control time in the variable optical attenuator 46 based on the value to identify the position of the own node sent to the node position information receiver 50 is as explained above. The inter-OSC communication data collector 66 adds the value to identify the position of the node received from the node position information transmitter 65, to the information received from the optical signal monitor/controller 67 for each wavelength, and transmits the value to the electrical-to-optical converter 69. The electrical-to-optical converter 69 converts the electrical data received from the inter-OSC communication data collector 66 to an optical signal, and transmits the optical signal to the OSC controller 44 of the next node.

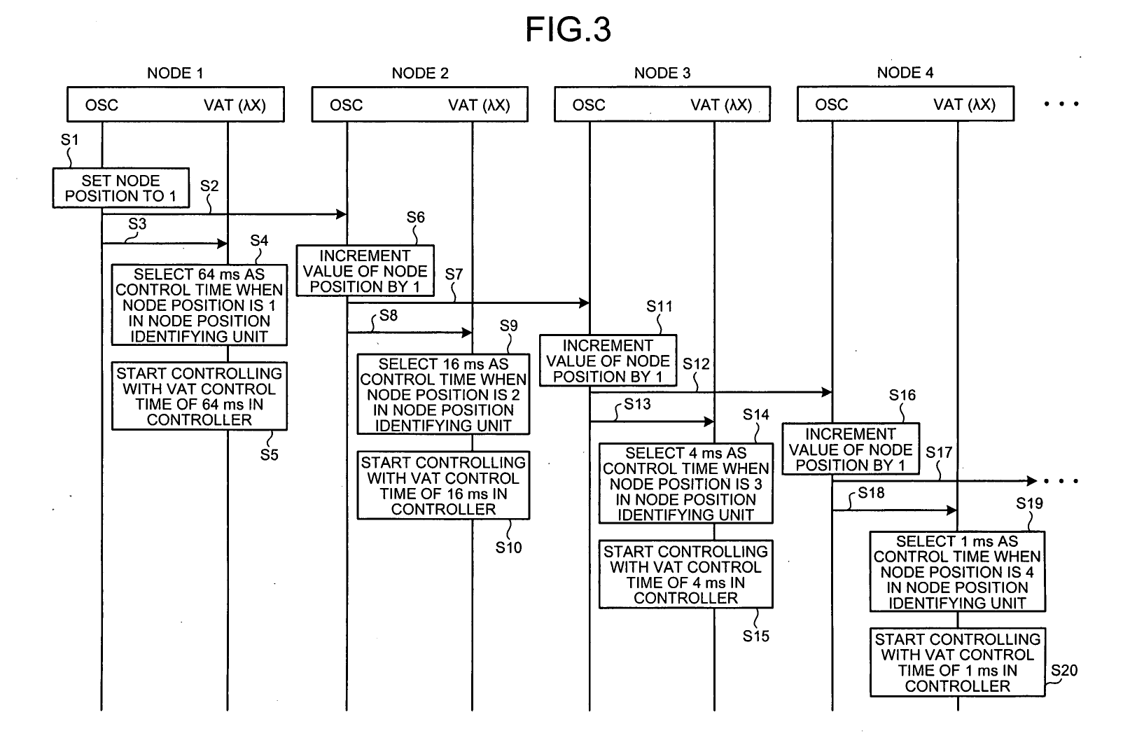

FIG. 3 is a diagram of an example of a sequence in the wavelength multiplexing method. When light of a client (wavelength: λX) is input to the node 1, the OSC controller 44 of the node 1 sets 1 in a node position parameter for λX in the data frame for the inter-OSC communication information (step S1). The inter-OSC communication information including the node position parameter for λX is sent to the node 2 (step S2).

In the node 1, the node position parameter for λX is also sent to the node position identifying unit 49 of the node 1 (step S3). The node position identifying unit 49 of the node 1 selects, for example, 64 milliseconds (ms) from the control-time table in the control-time table storage unit 56 as a control time corresponding to the value of the node position parameter that is 1 (step S4). And the controller 48 of the node 1 starts controlling the light attenuation amount based on the control time in the variable optical attenuator 46 for λX that is 64 ms (step S5).

In the node 2, the node position parameter for λX in the data frame for the inter-OSC communication information is incremented by 1, to be set to 2 (step S6). Inter-OSC communication information including the node position parameter for the λX is sent to the node 3 (step S7). Furthermore, in the node 2, the node position parameter for λX is also sent to the node position identifying unit 49 of the node 2 (step S8).

The node position identifying unit 49 selects, for example, 16 milliseconds (ms) from the control-time table in the control-time table storage unit 56, as a control time corresponding to the value of the node position parameter that is 2 (step S9). And the controller 48 of the node 2 starts controlling the light attenuation amount based on the control time in the variable optical attenuator 46 for λX that is 16 ms (step S10).

In the following, the same goes for the node 3 (steps S11 to S15) and the node 4 (steps S16 to S20). However, in the node 3, the node position parameter for λX in the data frame for the inter-OSC communication information is 3 (step S1), and the control time in the variable optical attenuator 46 corresponding to the value is 4 milliseconds (ms) (steps S14, S15). Furthermore, in the node 4, the node position parameter for λX in the data frame for the inter-OSC communication information is 4 (step S16), and the control time in the variable optical attenuator 46 corresponding to the value is 1 millisecond (ms) (steps S19, S20).

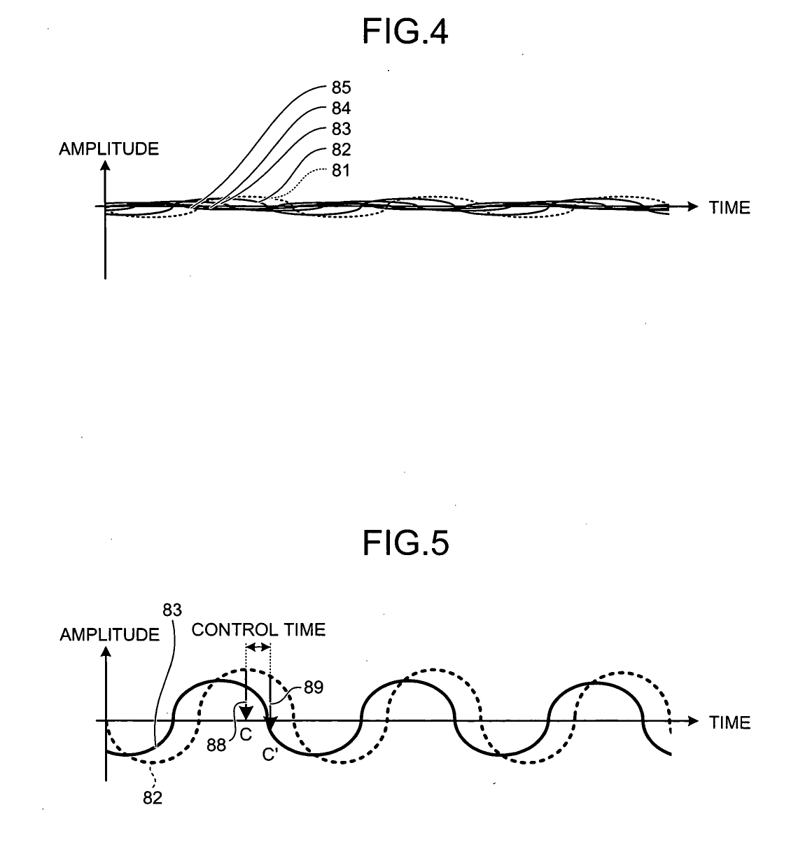

In the embodiment of the present invention, the control time in the variable optical attenuator 46 in the respective nodes becomes ¼ of the control time in the variable optical attenuator 46 in the immediately preceding node. Therefore, as shown in FIG. 4, the fluctuation in the level of a fine light from the initial node can be suppressed from being accumulated in the node in the subsequent stage. As shown in FIG. 4, reference numeral 81 represents a waveform of the incident light to the node 1, 82 a waveform of the output light from the node 1 (incident light to the node 2), 83 a waveform of the output light from the node 2 (incident light to the node 3), 84 a waveform of the output light from the node 3 (incident light to the node 4), and 85 a waveform of the output light from the node 4.

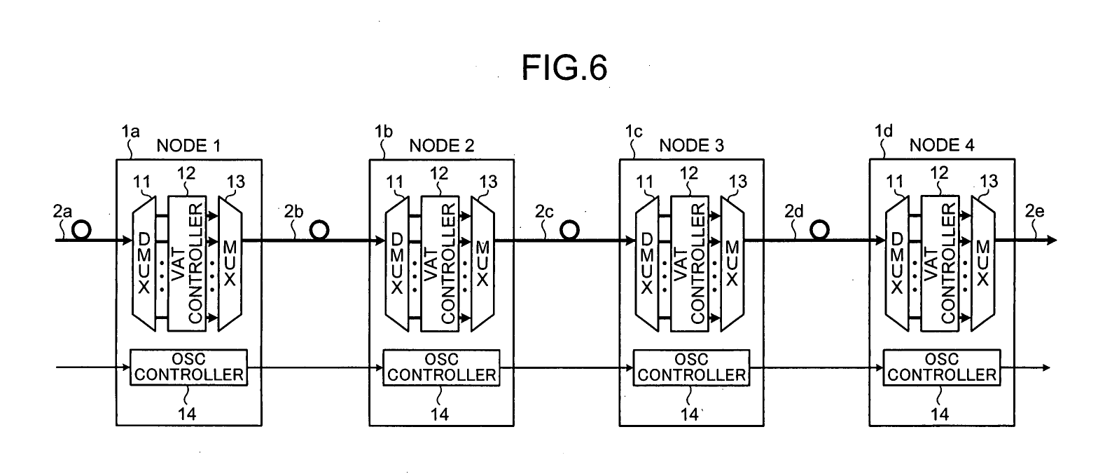

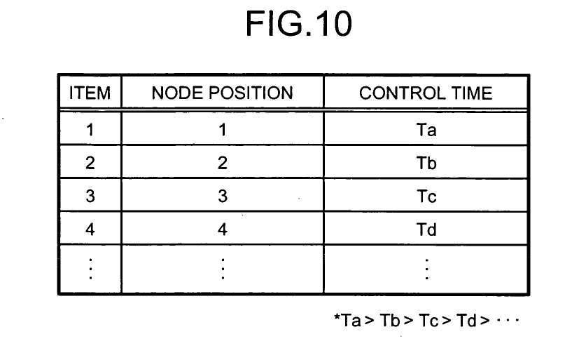

The reason that the accumulation of the fluctuations in the light levels can be suppressed as shown in FIG. 4 is explained below as compared with the conventional technology with reference to FIG. 8 and FIG. 9, for simplicity. A relationship between the incident light 81 and the output light 82 in the node 1 is the same as that between the incident light 31 and the output light 32 in the conventional node 1 of FIG. 8. However, as shown in FIG. 5, in the node 2, to suppress fluctuation of the incident light 82 to the node 2 at time C, the VAT controller 42 controls so as to suppress the amplitude of the incident light 82, in the direction indicated by an arrow 88 and by the length of the arrow 88 at time C.

In contrast to this, the control actually works as indicated by an arrow 89 in the same direction and by the same length as these of the arrow 88 at time C′ delayed by a time of ¼ of the control time in the node 1. Therefore, the output light 83 from the node 2 becomes a wave such that the incident light 82 to the node 2 is changed by the length of the arrow 89, and the amplitude decreases. The same goes to the node 3 and thereafter. In this manner, even if the stages of the nodes increase, the increase in the amplitude of the fluctuation can be suppressed.

It should be noted that the present invention is not limited to the embodiments, and hence, various modifications are possible. For example, the control time in the variable optical attenuator 46 of the respective nodes is not limited to ¼ of the control time in the variable optical attenuator 46 of an immediately preceding node. However, if the control time in the variable optical attenuator 46 is made shorter following a node in a further subsequent stage, the effect of suppressing the amplitude of the fluctuation is higher, which is preferable. Furthermore, the present invention is also applicable to a ring network or a network in any form other than an open-type ring network.

According to one aspect of the present invention, the control time required for controlling the output level of a light for each wavelength is set to a shorter time than the control time in the immediately preceding node, thereby suppressing the fluctuation in the level of light from the initial node, from being accumulated in the node in the subsequent stage. Thus, in the WDM optical transmission system in which the nodes are connected in multiple stages, the number of connections of nodes in multiple stages can be remarkably increased.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for an intermediate node to control a level of a signal included in a wavelength-multiplexed signal and transmitted from a source node to a destination node via the intermediate node, the method comprising:
demultiplexing the wavelength-multiplexed signal to extract the signal;
detecting a level of the signal;
identifying a position of the intermediate node with respect to the source node;
determining a control time based on the position;
controlling, when the control time has elapsed from the detecting, a level of the signal based on the level detected at the detecting; and
multiplexing the signal into the wavelength-multiplexed signal.

2. The method according to claim 1, wherein the control time determined in the intermediate node is shorter than that determined in a previous node that is adjacent to the intermediate node and located between the source node and the intermediate node.

3. The method according to claim 1, wherein the control time determined in the intermediate node is substantially ¼ of that determined in a previous node that is adjacent to the intermediate node and located between the source node and the intermediate node.

4. The method according to claim 1, wherein the position of the intermediate node is indicated by number of nodes between the source node and the intermediate node.

5. The method according to claim 4, wherein the position of the intermediate node is identified by adding 1 to a number indicating a position of a previous node and notified from the previous node that is adjacent to the intermediate node and located between the source node and the intermediate node.

6. The method according to claim 4, wherein the position of the intermediate node is identified as 1 when the intermediate node is the source node.

7. The method according to claim 1, wherein the source node, the destination node, and the intermediate node form any one of a ring network and an open-type ring network.

8. An apparatus that functions as an intermediate node and controls a level of a signal included in a wavelength-multiplexed signal and transmitted from a source node to a destination node via the apparatus, the apparatus comprising:
a demultiplexing unit that demultiplexes the wavelength-multiplexed signal to extract the signal;
a detecting unit that detects a level of the signal;
an identifying unit that identifies a position of the apparatus with respect to the source node;
a determining unit that determines a control time based on the position;
a control unit that controls, when the control time has elapsed from when the level of the signal is detected by the detecting unit, a level of the signal based on the level detected by the detecting unit; and
a multiplexing unit that multiplexes the signal into the wavelength-multiplexed signal.

9. The apparatus according to claim 8, wherein the control time determined in the apparatus is shorter than that determined in a previous node that is adjacent to the apparatus and located between the source node and the apparatus.

10. The apparatus according to claim 8, wherein the control time determined in the apparatus is substantially ¼ of that determined in a previous node that is adjacent to the apparatus and located between the source node and the apparatus.

11. The apparatus according to claim 8, wherein the position of the apparatus is indicated by number of nodes between the source node and the apparatus.

12. The apparatus according to claim 11, wherein the position of the apparatus is identified by adding 1 to a number indicating a position of a previous node and notified from the previous node that is adjacent to the apparatus and located between the source node and the apparatus.

13. The apparatus according to claim 11, wherein the position of the apparatus is identified as 1 when the apparatus functions as the source node.

14. The apparatus according to claim 8, wherein the source node, the destination node, and the apparatus form any one of a ring network and an open-type ring network.

15. The apparatus according to claim 8, further comprising a storage unit that stores a relation between the position and the control time.
